(19) United States
(12) Patent Application Publication
(10) Pub. No.: US 2024/0176348 A1
(43) Pub. Date: May 30, 2024

(54) SYSTEM AND METHOD FOR AUTONOMOUS NAVIGATION OF A FIELD ROBOT

(71) Applicant: EARTHSENSE INC., Champaign, IL (US)

(72) Inventors: Girish CHOWDHARY, Champaign, IL (US); Mateus GASPARINO, Urbana, IL (US); Arun NARENTHERIAN, Champaign, IL (US); Akihiro HIGUTI, Champaign, IL (US); Andres BAQUERO, Urbana, IL (US)

(21) Appl. No.: 18/072,114

(22) Filed: Nov. 30, 2022

(51) Int. Cl. G05D 1/02; G05D 1/00

(52) U.S. Cl. CPC G05D 1/0212; G05D 1/0088; G05D 1/0094; G05D 2201/0201

(57) ABSTRACT

A system and a method for autonomous navigation of a field robot (FR) is disclosed. The system receives a current location of the FR, a target location, and a sequence of checkpoints within a field. The system then determines a direction of navigation for the FR based on the current location, the target location, and the sequence of checkpoints. Further, the system obtains a set of images of parts of the field from cameras installed on the FR. Subsequently, the system determines a coefficient of traversal of the parts of the field in the set of images. The system determines one or more traversable areas based on the coefficient of traversal. Finally, the system identifies a traversable route for the FR to navigate to a checkpoint or the target location.

### PRIORITY INFORMATION

The present application does not claim priority from any other application.

### TECHNICAL FIELD

The present subject matter described herein, in general, relates to autonomous navigation of a robot, and, more particularly, to the autonomous navigation of a field robot.

### BACKGROUND

Robotics and digital agriculture technologies hold great potential to improve sustainability, productivity, and access to agriculture. Agricultural robots have been developed to solve a critical issue of a shortage of workforce in agriculture. To reduce the amount of workforce required, the agricultural robots are equipped with autonomous navigation for performing various agricultural tasks, such as planting and harvesting, plant scouting, treatment of pests, and diseases. While autonomous navigation of agricultural robots has been an active area of research, conventional systems are not fully equipped for real world scenarios. For example, achieving true autonomous navigation in the real-world scenario is challenging because, unlike the flat terrain used for vehicular transportation, agricultural fields are spread over patches of distinct and uneven terrains. Geographically, agricultural fields are mostly located in remote areas and with low network connectivity. Using traditional technologies such as GPS (Global Positioning System) and image processing over cloud-based systems can be challenging due to low network connectivity. Such an autonomous navigation system may also be used for robots in applications other than agriculture, such as construction, forward base support in military operations, excavation, mining operations, remote area exploration, disaster support, and the like. Therefore, there is a need for a safer, more accurate, and more efficient method and system for the autonomous navigation of field robots.

### SUMMARY

Before the present system(s) and method(s), are described, it is to be understood that this application is not limited to the particular system(s), and methodologies described, as there can be multiple possible embodiments that are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for autonomous navigation of agricultural robots. This summary is not intended to identify essential features of the claimed subject matter, nor is it intended for use in determining or limiting the scope of the claimed subject matter.

In one implementation, a method for autonomous navigation of a field robot (FR) is disclosed. The field robot may also be an agricultural field robot (AFR). The method involves receiving a current location of the FR, a target location, and a sequence of checkpoints within a field. Further, a direction of navigation for the FR may be determined based on the current location, target location, and the sequence of checkpoints. The direction may be determined using a Global Positioning System (GPS), and a Global Navigation Satellite System (GNSS) based on the current location of the FR, and the location of a checkpoint or the target location. The direction may change as the robot's current location changes. Further, a set of images may be obtained in real-time from one or more cameras installed on the FR during navigation of the FR in the determined direction. The set of images may comprise RGB (Red, Green, and Blue) images and depth images of parts of the field. The set of images may be obtained continuously while the FR moves and the current location of the FR changes.

Further, coefficients of traversal of the plurality of parts of the field in each image of the set of images may be determined using one or more machine learning models and a kinodynamic motion planning model (KMPM). The coefficient of traversal of a part of the field may be a value between 1 and 0. The coefficient of traversal may be 1 when the part of the field is most traversable and 0 when the part of the field is least traversable. Finally, a traversable route may be identified for the FR based on the coefficients of traversal of the plurality of parts, the target location, and the sequence of checkpoints using a route identification model.

In another implementation, the method may comprise determining the coefficients of traversal of the plurality of parts of the field in each image of the set of images based on at least one of one or more obstacles, types of terrain of the plurality of parts of the field, a future motility of the FR in the types of terrain. The method may comprise detecting one or more obstacles in each image of the set of images using an obstacle detection model. Further, types of terrain of the plurality of parts of the field in the set of images may be identified using a terrain identification model. Further, a future motility of the FR in the identified types of terrain may be predicted using the Kinodynamic Motion Planning Model (KMPM). The future motility of the FR in the identified type of terrain may be predicted based on direction, angular velocity, acceleration, yaw, pitch, roll angles, traction, and velocity of the FR.

In another implementation, the method may involve using a path planning robot to determine the coefficient of traversal of the plurality of parts of the field for the FR by obtaining a set of training images from one or more cameras installed on the path planning robot. Further, coefficients of traversal of the plurality of parts of the field in each image of the set of training images for the path planning robot may be determined using one or more machine learning models and a kinodynamic motion planning model (KMPM).

Further, a set of images of the field in real-time may be obtained from one or more cameras installed on the FR. Subsequently, training information comprising the coefficients of traversal, for the path planning robot, of the plurality of parts of the field in the set of training images may be received. Further, the KMPM may be modified based on geometrical difference and mechanical difference between the path planning robot and the FR using geometric projections. Further, the coefficient of traversal, for the FR, of the plurality of parts of the field in each image of the set of images may be determined using the one or more machine learning models and the modified KMPM.

Further, the method may comprise highlighting one or more parts from the plurality of parts of the field. The highlighted one or more parts may have the coefficient of traversal greater than a defined threshold. Finally, the method may comprise identifying a traversable route for the FR based on the coefficients of traversal of the plurality of parts, the target location, and the sequence of checkpoints using a route identification model. In one aspect, the aforementioned method for autonomous navigation of a field robot may be performed by a processor using programmed instructions stored in a memory.

In another implementation, a non-transitory computer-readable medium embodying a program executable in a computing device for autonomous navigation of a field robot is disclosed. The program may comprise a program code for receiving a current location of the FR, a target location and a sequence of checkpoints within a field. Further, the program may comprise a program code for determining a direction of navigation for the FR based on the current location, target location and the sequence of checkpoints. The direction may be determined using GPS and GNSS based on the current location of the FR and location of a checkpoint or the target location. The direction may change as the robot's current location changes. Further, the program may comprise a program code for obtaining a set of images in real-time from one or more cameras installed on the FR during navigation of the FR in the determined direction. The set of images may comprise RGB images (Red Green Blue images) and depth images of parts of the field. The set of images may be obtained continuously while the robot moves and the current location of the field robot changes.

Further, the program may comprise a program code for determining coefficients of traversal of the plurality of parts of the field in each image of the set of images using one or more machine learning models and a kinodynamic motion planning model (KMPM). The coefficient of traversal of a part of the field may be a value between 1 and 0. The coefficient of traversal may be 1 when the part of the field is most traversable and 0 when the part of the field is least traversable. Finally, the program may comprise a program code for identifying a traversable route for the FR based on the coefficients of traversal of the plurality of parts, the target location, and the sequence of checkpoints using a route identification model.

In another implementation, the program may comprise a program code for determining the coefficients of traversal of the plurality of parts of the field in each image of the set of images based on at least one of one or more obstacles, types of terrain of the plurality of parts of the field, a future motility of the FR in the types of terrain. The program may comprise a program code for detecting one or more obstacles in each image of the set of images using an obstacle detection model. Further, the program may comprise a program code for identifying types of terrain of the plurality of parts of the field in the set of images using a terrain identification model. Further, the program may comprise a program code for predicting a future motility of the FR in the identified types of terrain using the Kinodynamic Motion Planning Model (KMPM). The future motility of the FR in the identified type of terrain may be predicted based on direction, angular velocity, acceleration, yaw, pitch, roll angles, traction, and velocity of the FR.

In another implementation, the program may comprise a program code for using a path planning robot to determine the coefficient of traversal of the plurality of parts of the field for the FR by obtaining a set of training images from one or more cameras installed on the path planning robot. Further, the program may comprise a program code for determining coefficients of traversal, for the path planning robot, of the plurality of parts of the field in each image of the set of images using one or more machine learning models and a kinodynamic motion planning model (KMPM).

Further the program may comprise a program code for obtaining a set of images of the field in real-time from one or more cameras installed on the FR. Subsequently, the program may comprise a program code for receiving training information comprising coefficients of traversal, for the path planning robot, of the plurality of parts of the field in each image of the set of images. Further, the program may comprise a program code for modifying the KMPM based on geometrical difference and mechanical difference between the path planning robot and the FR using geometric projections. Further, the coefficient of traversal, for the FR, of the plurality of parts of the field in each image may be determined using the one or more machine learning models and the modified KMPM.

Further, the program may comprise a program code for highlighting one or more parts from the plurality of parts of the field. The highlighted one or more parts may have the coefficient of traversal greater than a defined threshold. Finally, the program may comprise a program code for identifying a traversable route for the FR based on the coefficients of traversal of the plurality of parts, the target location, and the sequence of checkpoints using a route identification model.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, however, the invention is not limited to the specific method and system for autonomous navigation of a field robot disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation for autonomous navigation of a field robot, in accordance with an embodiment of the present subject matter.

FIG. 2 illustrates a method for autonomous navigation of a field robot, in accordance with an embodiment of the present subject matter.

FIG. 3 illustrates pairs of images comprising a plurality of parts of a field highlighted based on coefficients of traversal of the plurality of parts of the field, in accordance with an embodiment of the present subject matter.

FIG. 4 illustrates example of a traversable route from a current location of a field robot to a target location, in accordance with an embodiment of the present subject matter.

FIG. 5 illustrates an example of a current location, a sequence of checkpoints, and a target location, in accordance with an embodiment of the present subject matter.

FIG. 6 illustrates an example of direction determined by the system from the current location to checkpoint 1 in the example illustrated in FIG. 5, in accordance with an embodiment of the present subject matter.

FIG. 7 illustrates an example of an image of a field and a set of trajectories sampled by the system, in accordance with an embodiment of the present subject matter.

FIG. 8 illustrates an example artificial neural network, in accordance with an embodiment of the present subject matter.

The figures depict an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving,” “determining,” “obtaining,” “detecting,” “predicting,” “identifying,” “updating,” “computing.” “selecting,” and other forms thereof, are intended to be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present subject matter discloses a method and a system for autonomous navigation of a field robot (FR). Autonomous navigation refers to the FR's ability to determine its own position in its frame of reference and then to plan a path towards a target location. In other words, autonomous navigation is the ability of the FR to learn and execute movement of its path without any human intervention. Autonomous navigation of the FR is utilized to perform various agricultural tasks such as planting, harvesting, fertilization, and alike.

In an embodiment, the system may receive a target location. The FR may navigate towards the target location. Further, the system may receive a sequence of checkpoints for the robot to pass through before reaching the target location. The checkpoints may be locations in the field that need to be worked on by the FR by performing some type of agricultural task such as planting, seeding, harvesting, fertilizing, and the like. Further, the system may receive a current location of the FR using GPS and GNSS to locate the position of the FR in the field. The system may determine a direction (north, south, east, west, etc.) for the FR to face while beginning the navigation in order to reach the next checkpoint or the target location based on the current location, sequence of checkpoints, and the target location.

Once the FR faces the direction determined by the system, the system may obtain a set of images using one or more cameras installed on the FR. The set of images may comprise RGB images, also known as color images or vision images, and depth images of the field. Each image may comprise a plurality of parts of the field. Further, the system may detect one or more obstacles in the plurality of parts of the field using an obstacle detection model. Further the system may identify types of terrain of the plurality of parts of the field in each image of the set of images using a terrain identification model. It may be noted that the field may have various types of terrains such as snowy, muddy, rocky, grassy, and the like.

Further, the system may use a Kinodynamic Motion Planning Model (KMPM) to determine a future motility of the FR in the plurality of parts of the field. The term “future motility” of the FR refers to the ability of the FR to traverse through a part of the field. The system may then determine coefficients of traversal for the plurality of parts of the field based on the one or more obstacles detected and the future motility of the FR in the part of the field. The coefficients of traversal may be a value between 0 and 1. The coefficients of traversal may be 0 when a part of the field may be least traversable and 1 when a part of the field may be most traversable for the FR.

Finally, the system may identify a traversable route for the FR to reach a checkpoint or the target location based on the coefficients of traversal of the plurality of parts, the target location, and the sequence of checkpoints using a route identification model.

Certain technical challenges exist in the autonomous navigation of an FR. One technical challenge faced while determining a coefficient of traversal of a part of a field to determine whether the FR can travel through the part of the field is that a part of the field may have obstacles and different terrains such as muddy, snowy, rocky, and the like. The FR may have a set of mechanical properties that determine the type of terrain suitable for the use of the FR. For example, a heavy FR may have an ability to travel through a snowy terrain, but it may not be able to travel through a muddy terrain. The solution presented in the embodiments disclosed herein to address the above challenge is predicting future motility of the FR using a kinodynamic motion planning model (KMPM). The KMPM may be trained using supervised learning, self-learning, recursive learning, and transfer learning. The KMPM may be trained to determine whether the FR will be able to travel through a part of the field based on inertial factors like velocity, acceleration, angular velocity of the FR, and inertial properties like yaw, pitch and roll angles of the FR by calculating the coefficient of traversal.

In an embodiment, the KMPM may be used to compute traction between the FR's tires and the terrain of the part of the field based on parameters including weight of the FR, frictional coefficient of material of the tire, frictional coefficient of the terrain of the part of the field, weight of the load carried by the FR. The KMPM may determine whether the traction computed is enough for the tires of the FR to roll and not slip, making the part of the field traversable for the FR.

Another technical challenge faced in the autonomous navigation of an FR is that cameras on the FR may get soiled during operation due to dusty or muddy terrain. The cameras may capture unclear images as a result of soiling. The soiling may cause misinterpretation of an image and failure to detect an obstacle. This may lead to the FR crashing into an obstacle. Field robots may have expensive and fragile equipment attached to them, which may get damaged. The solution presented in the embodiments disclosed herein to address the above challenge is using transfer learning to train the obstacle detection model, terrain identification model, and the KMPM for the FR. Transfer learning involves using a smaller robot or a path planning robot to gather information of the field. The information may comprise one or more obstacles detected by the path planning robot and types of terrain of a plurality of parts of the field. Further, the information gathered from the path planning robot is used to train the obstacle detection model, terrain identification model, and the KMPM that are used for autonomous navigation of the FR.

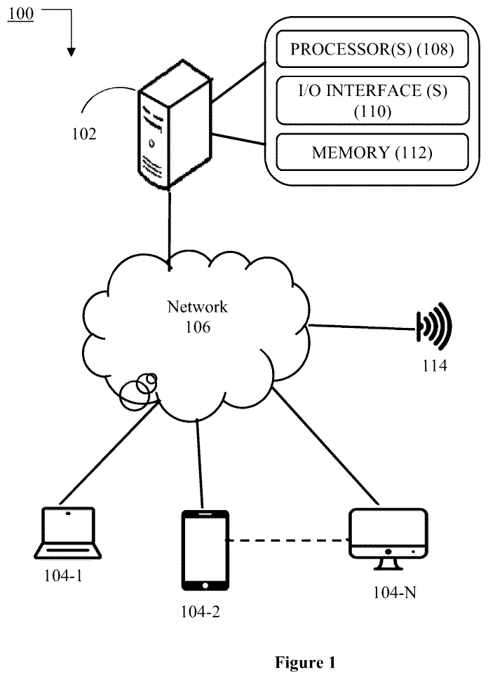

Referring now to FIG. 1, a network implementation 100 of a system 102 for autonomous navigation of a field robot is disclosed. Initially, the system 102 receives a target location, and a sequence of checkpoints within a field from a user through a graphical user interface (GUI). In an example, the user may use an application installed on a user device 104-1 having the GUI to input the target location and the sequence of checkpoints. It may be noted that the one or more users may access the system 102 through one or more user devices 104-1, 104-2 . . . 104-N, collectively referred to as user devices 104, hereinafter, or applications residing on the user devices 104.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, or a cloud-based computing environment. It will be understood that the system 102 may be accessed by multiple users through one or more user devices 104-1, 104-2 . . . 104-N. In one implementation, the system 102 may comprise the cloud-based computing environment in which the user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 may include at least one processor 108, an input/output (I/O)) interface 110, and a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

The system 102 may receive data from a sensor network 114. The sensor network may include camera sensors, inertial sensors, LIDAR, location sensors, and the like installed on the FR.

As there are various challenges observed in the existing art, the challenges necessitate the need to build the system 102 for autonomous navigation of a field robot. At first, a user may use the user device 104 to access the system 102 via the I/O interface 110. The user may register the user devices 104 using the I/O interface 110 in order to use the system 102. In one aspect, the user may access the I/O) interface 110 of the system 102. The detail functioning of the system 102 is described below with the help of figures.

The system as described herein is configured to execute a set of instructions for autonomous navigation of a field robot (FR). The system may receive a target location and a sequence of checkpoints within a field from a user. The field may be an agricultural land having plantations or orchards. The target location may be a part of the field that may need some agricultural treatment such as harvesting, fertilization, inspection, and the like. The checkpoints may be intermediate locations in the field that may also require some agricultural treatment. The FR may sequentially cover each checkpoint performing the agricultural treatment and reach the target location.

In an alternate embodiment, the system may receive a target location and a set of checkpoints. Further, the system may receive the FR's current location using GPS and GNSS. Furthermore, the system may automatically determine the sequence of checkpoints based on the direction of the FR and the target location. It may be noted that the system determines the sequence of checkpoints in order to reach all the checkpoints in the shortest time by traveling the shortest distance. The sequence is automatically determined using machine learning techniques.

Further, the system may receive the FR's current location using a Global Positioning System (GPS), and a Global Navigation Satellite System (GNSS) to locate the position of the FR in the field at a given moment in time. The system may determine a direction for the FR to begin navigation toward a checkpoint or the target location based on the current location, the sequence of checkpoints, and the target location. The system may use a machine learning model to determine the direction. The machine learning model may be trained using supervised learning. The machine learning model may be trained using a training dataset comprising a plurality of current locations, a plurality of target locations, and a labeled set of directions for each of the plurality of current locations to each of the plurality of target locations. The machine learning model processes each direction from the labeled set of directions along with a corresponding current location and a corresponding target location. Further, the machine learning model produces a direction as an output for a current location and a target location outside the training dataset using the processed training dataset.

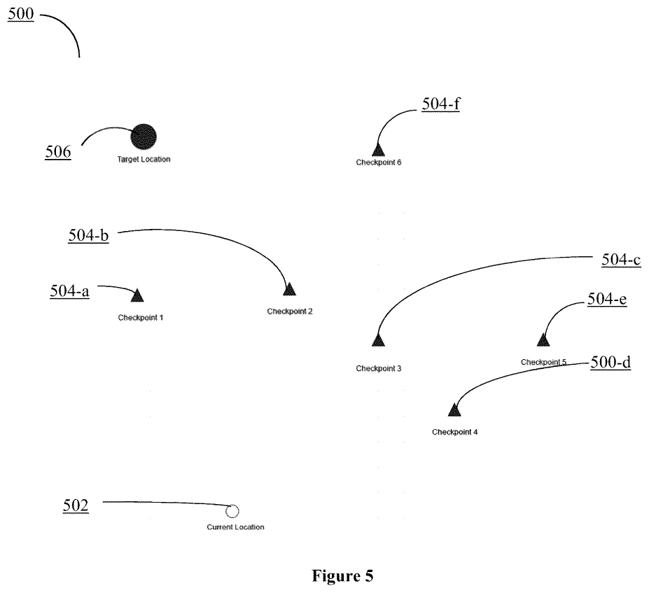

FIG. 5 illustrates an example (500) wherein the system receives a current location of the FR (502), a sequence of checkpoints (504-a, 504-b . . . 504-f), and a target location (506). Let us assume that the current location, the sequence of checkpoints, and the target location are as shown in FIG. 5.

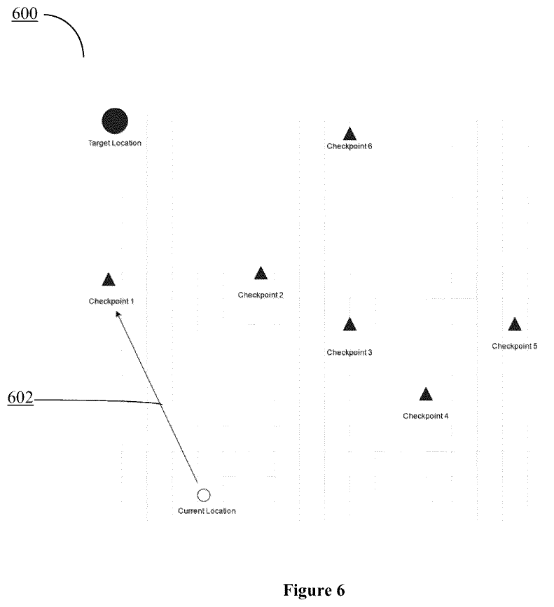

FIG. 6 illustrates the direction (602) determined using the machine learning model from the current location (502) to a checkpoint 1 (504-a) for the example in FIG. 5.

In an embodiment, the system may determine the direction towards the next checkpoint or the target location at each checkpoint. The FR may be directed to face in the direction determined by the system to begin navigation. The FR may need to pass through each checkpoint sequentially before reaching the target location. The system may track the current location of the FR continuously to ensure completion of each checkpoint in the sequence.

Further, the system may obtain a set of images, in real-time, using one or more cameras installed on the FR. The system may obtain the set of images continuously while the FR navigates towards a checkpoint or the target location. The set of images may comprise RGB (Red, Blue, Green) images and depth images. The RGB images may be used to identify different types of terrains based on color information in the RGB images. The depth images may be used to detect obstacles and to determine distance of an obstacle from the FR. As an example, and not by way of limitation, the one or more cameras may include a monocular camera and a depth-sensing camera. In an embodiment, the cameras may be installed in the body of the FR or may be placed on the FR using a pivoted support such as a gimbal support. Each image of the set of images may capture a plurality of parts of the field immediately surrounding the FR. The plurality of parts of the field captured in an image may depend on the field of vision of the cameras. The field of vision defines the maximum area of a sample that the camera can capture. The field of vision is determined by the focal length of lens of the camera and sensor size of the camera. It may be noted that each image may have a plurality of parts of the field having different terrains, gradients, and/or obstacles.

Further, the system may analyze the set of images to determine coefficients of traversal of the plurality of parts of the field. In an embodiment, the system may detect one or more obstacles in the plurality of parts of the field in the set of images using an obstacle detection model. Further, the system may identify types of terrain of the plurality of parts of the field in the set of images using a terrain identification model. The obstacle detection model and the terrain identification model may be trained using a training dataset of the set of images, labeled obstacles, and labeled terrains in the set of images. In an embodiment, the system may clean the set of images to remove duplicates. The obstacle detection model may be trained to produce an output comprising one or more obstacles in an image for an input of an image outside the training dataset. The terrain identification model may be trained to produce an output comprising the types of terrain for a plurality of parts in an image outside the training dataset. The obstacle detection model and the terrain identification model may use Artificial Neural Networks (ANN) for accurate outputs.

Subsequently, the system may predict a future motility of the FR in the identified type of terrain using a Kinodynamic Motion Planning Model (KMPM). The future motility may be predicted based on direction, angular velocity, acceleration, yaw, pitch, roll angles, traction, and velocity of the FR. The future motility of the FR corresponds to a resulting motion of the FR in a type of terrain with a particular set of values of velocity, angular velocity, acceleration, traction, direction. As an example, and not by way of limitation, the future motility of the FR may be at least one of rolling, moving, stuck, toppled, skidding, immobile, and the like. For example, the future motility of the FR in a snowy type of terrain with a velocity of 3 mph, angular velocity of 5 rad/s, and acceleration 2 m/s² may be predicted as “skidding or toppled.”

In an embodiment, the KMPM may be trained to predict the future motility of the FR using supervised learning techniques. The KMPM may be trained using a training dataset comprising a set of images, types of terrain, a plurality of velocities, a plurality of angular velocities, a plurality of acceleration values, a plurality of directions, yaw, pitch, roll angles, traction of the FR, and predicted future motility of the FR for each of the plurality of values in the training data set. The KMPM may be trained to output a predicted future motility of the FR when given an input comprising a type of terrain, a velocity, an angular velocity, acceleration, direction, traction, yaw, pitch and roll angles of the FR. In an embodiment, the system may calculate the traction between the wheels of the FR and the type of terrain based on weight of the FR, a frictional coefficient of the tires and a frictional coefficient of the type of terrain.

In another embodiment, the KMPM may be trained using transfer learning. Training the KMPM using transfer learning may comprise using a path planning robot to explore the field. The system may obtain a set of training images from cameras installed on the path planning robot. Further, the system may detect one or more obstacles in the field from the set of training images. The system may also identify types of terrains of a plurality of parts of the field in each image of the set of training images. Further, the system may predict a future motility of the path planning robot in the identified types of terrains using a KMPM. The KMPM may predict the future motility of the path planning robot in the plurality of parts of the field in the set of training images based on direction, angular velocity, acceleration, yaw, pitch, roll angles, traction, and velocity of the path planning robot. Further, the system receives training information comprising the detected one or more obstacles and the types of terrain for the set of training images. Further, the system modifies the KMPM based on geometrical and mechanical difference between the path planning robot and the FR using geometric projections. The geometrical difference may be determined by comparing dimensions of the path planning robot and the FR, the mechanical difference may be determined by comparing velocity, angular velocity, acceleration, yaw, pitch, and roll angles of the path planning robot and the FR. The dimensions of the path planning robot and the FR may include their height, width, length, and wheel diameter.

In an embodiment, the KMPM may be defined as the Equation 1.

$$\dot{x} ( t ) = [ \begin{matrix}{\dot{p}}_{x} ( t ) \\ {\dot{p}}_{y} ( t ) \\ \dot{θ} ( t )\end{matrix} ] = [ \begin{matrix}μ \cdot cos ( θ ( t ) ) & 0 \\ μ \cdot sin ( θ ( t ) ) & 0 \\ 0 & v\end{matrix} ] [ \begin{matrix}v ( t ) \\ ω ( t )\end{matrix} ] \qquad Equation 1$$

In the equation 1, x(t) is the state vector composed of \dot{p}ₓ(t), \dot{p}_{y}(t) and \dot{θ}(t) representing position in x and y axis and heading angle, respectively, in the world coordinate frame. μ and v are unknown parameters and can be related to traction caused by the interaction between wheels of the FR and the terrain. v(t) and ω(t) are the velocity and angular velocities of the FR.

In another embodiment, the KMPM may be trained with self-supervision techniques using a Nonlinear Moving Horizon Estimator (NHME) and an Extended Kalman Filter (EKF). The NHME uses the equation 1 to predict a future motility of the FR. The output of the NHME may be used to correct predictions made by the EKF.

In an embodiment, the system may arrange the set of images in a sequence. Further, the system may create a 3-D model of the nearby surroundings of the FR from the sequence of images using 3-D modeling machine learning algorithms. The 3-D modeling machine learning algorithms may include NeRF, FvOR, PyTorch, DeepVO, CNN. The system may generate a top down view for the FR based on the 3-D model using NeRF and CNN.

Further to analyzing the images, the system may determine the coefficients of traversal of the plurality of parts the field in each image of the set of images for the FR. The coefficients of traversal may be determined based on the one or more obstacles detected, the type of terrain, and the future motility of the FR. The coefficients of traversal may be a value between 1 and 0. The coefficients of traversal of a part of the field may be 1 when the part of the field is most traversable and 0 when the part is least traversable. The coefficients of traversal may be determined using a machine learning model. The machine learning model may be trained using a training data set comprising a set of images of a field, one or more obstacles detected in each image of the set of images, types of terrain of a plurality of parts of the field in each image, future motility of the FR in the plurality of parts of the field in each image of the training dataset and a coefficient of traversal for each part of the field in each image. The future motility in the training dataset may be received from a human participant controlling the FR and observing the future motility of the FR in the parts of the field in the set of images of the training dataset. The machine learning model may be trained to produce an output comprising coefficients of traversal for a plurality of parts of the field in a set of images outside the training dataset for an input comprising the set of images, one or more obstacles detected in the set of images, the types of terrain of the plurality of parts of the field in the set of images, the future motility of the FR in the plurality of parts of the field.

In an embodiment, the system may determine the coefficients of traversal of the plurality of parts of the field using a recursive learning model. The system may use historical data of a plurality of field robots to train the recursive learning model. The historic data may comprise a plurality of sets of images, coefficients of traversal for each part of the field in the plurality of sets of images. The coefficients of traversal may be determined at least by using one or more machine learning models including the obstacle detection model, and the terrain identification model, and the KMPM, and by receiving annotations from the human participant controlling the plurality of field robots. The recursive learning model may be trained to produce a coefficient of traversal for a part of the field as an output for an input of an image comprising the part of the field.

Consider an example, an image having a part of the field with an obstacle in 20% of the part of the field, having a plain type of terrain, having a future motility “immobile”. The coefficient of traversal for the part of the field may be determined to be 0.3.

Consider another example, an image having a part of the field with no obstacles, having a plain type of terrain, and having future motility “moving”. The coefficient of traversal for the part of the field may be determined to be 1.

In an embodiment, the system may continuously update the coefficients of traversal of the plurality of parts of the field. The coefficients of traversal may be updated when the FR travels through the parts of the field. The system may receive inertial information of the FR from one or more inertial sensors installed on the FR. The inertial information may comprise at least a current velocity, a current angular velocity, a current direction, and a current acceleration of the FR. Further, the system may determine a current motility of the FR for the part of field it is travelling through. The system may use the KMPM to determine the current motility of the FR based on the inertial information. Further, the system may compare the current motility of the FR for the part of the field with the predicted future motility of the FR for the part of the field. Subsequently, the system may update the coefficients of traversal for one or more parts from the plurality of parts of the field when the current motility of the FR does not match with the predicted motility for the one or more part from the plurality of parts of the field.

Further to determining the coefficients of traversal for the plurality of parts of the field in the set of images, the system may categorize one or more parts of the field as traversable or non-traversable based on the coefficient of traversal. The one or more part of the field may be categorized as traversable when the coefficient of traversal of the parts is greater than a defined threshold. In an example and not by way of any limitation, the threshold may be a value between 0 and 0.5 set by the user. The one or more parts of the field having the coefficients of traversal greater that the defined threshold may be highlighted in the set of images based on the coefficients of traversal. In the example, a part of the field having a coefficient of traversal equal to 0.6 may be highlighted in a light shade of grey, another part having a coefficient of traversal equal to 0.9 may be highlighted in a lighter shade of grey with respect to the part having the coefficient of traversal equal to 0.6.

Finally, the system may identify a traversable route for the FR based on the target location, the sequence of checkpoints, and the coefficient of traversal of each part of the field. The traversable route may be determined for each image such that the FR gets closer to a checkpoint or the target location following the traversable route. The system may sample a set of trajectories for the FR, in real-time, in each image based on the target location, sequence of checkpoints, and the coefficients of traversal of the plurality of parts of the field. In an embodiment, each trajectory may pass through one or more parts from the plurality of parts of the field having different coefficients of traversal. The system may compute an average coefficient of traversal based on the coefficients of traversal of the one or more part of the field that the trajectory passes through. Further, the system may select the trajectory having the highest average coefficient of traversal as the traversable route for the FR.

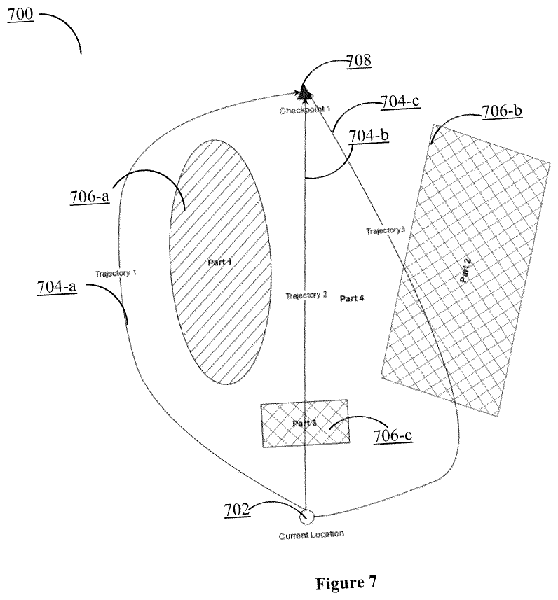

Referring to FIG. 7 illustrates three sample trajectories. Let us assume, the image in FIG. 7 comprises 4 parts of the field having the following coefficients of traversal— Part 1-0.6, Part 2-0.2, Part 3-0.8, Part 4-1. The average coefficient of traversal for Trajectory 1 may be equal to 1 since it only passes though Part 4 having a coefficient of traversal equal to 1. The average coefficient of traversal for Trajectory 2 may be 0.9 since it passes through Part 3 having a coefficient of traversal equal to 0.8 and Part 4 having a coefficient of traversal equal to 1. The average coefficient of traversal for Trajectory 3 may be 0.6 since it passes through Part 2 having coefficient of traversal equal to 0.2 and Part 4 having coefficient of traversal equal to 1.

In an embodiment, the average coefficient of traversal for each trajectory may be calculated using a mathematical model based on the total length of the trajectory, amount of length of the trajectory passing through a part of the field, coefficient of traversal of the part of the field.

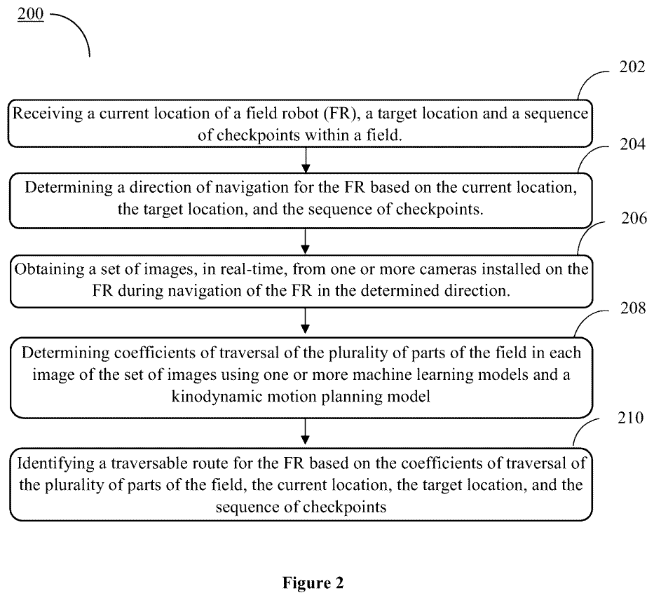

Referring now to FIG. 2, a method 200 for autonomous navigation of a field robot is shown, in accordance with an embodiment of the present subject matter. The method 200 may be described in the general context of computer executable instructions. Generally, computer executable instructions can include routines, programs, objects, components, data structures, procedures, modules, functions, etc., that perform particular functions or implement particular abstract data types.

The order in which the method 200 is described is not intended to be construed as a limitation, and any number of the described method blocks can be combined in any order to implement the method 200 or alternate methods for autonomous navigation of a field robot. Furthermore, the method 200 for autonomous navigation of a field robot can be implemented in any suitable hardware, software, firmware, or combination thereof. However, for ease of explanation, in the embodiments described below, the method 200 may be considered to be implemented in the above-described system 102.

At block 202, a current location of a field robot (FR), a target location and a sequence of checkpoints within a field may be received. The FR may sequentially travel through each checkpoint before reaching the target location. The target location, and the sequence of checkpoints may be received from a user for the FR to perform an agricultural treatment such as harvesting, fertilizing, inspecting, and the like at the checkpoints and the target location. The checkpoints may correspond to intermediate locations within a field that may require the agricultural treatment.

At block 204, a direction of navigation for the FR may be determined based on the current location, the target location, and the sequence of checkpoints.

At block 206, a set of images may be obtained, in real-time, from one or more cameras installed on the FR during navigation of the FR in the determined direction.

At block 208, coefficients of traversal of the plurality of parts of the field in each image of the set of images may be determined using one or more machine learning models and a kinodynamic motion planning model (KMPM).

At block 210, a traversable route for the FR may be identified based on the coefficients of traversal of the plurality of parts, the target location, and the sequence of checkpoints using a route identification model.

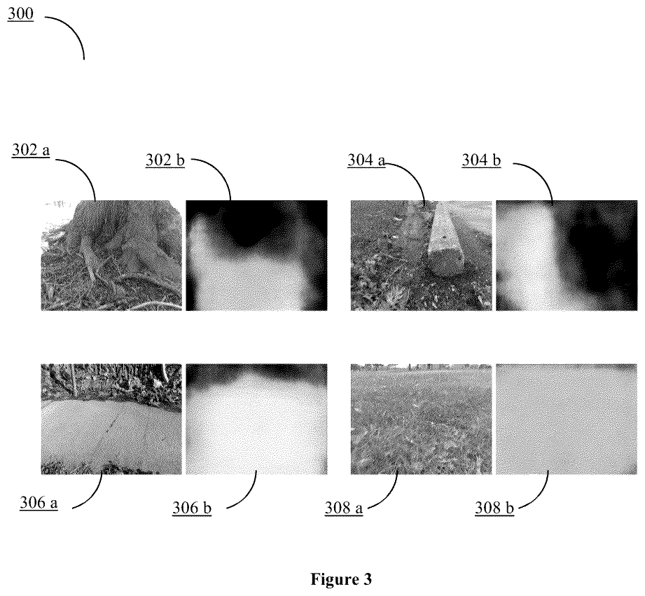

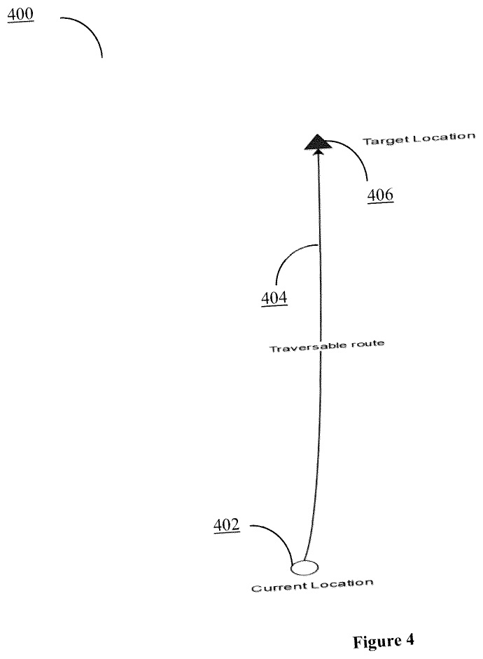

Referring to FIG. 3, an example (300) of pairs of images comprising a plurality of parts of a field is illustrated. The pairs of images comprise one or more parts having the coefficients of traversal greater than a defined threshold. The one or more parts having the coefficients of traversal greater than the defined threshold are highlighted in an image as shown. In the FIG. 4 pairs (302-a and 302-b, 304-a and 304-b, 306-a and 306-b, and 308-a and 308-b) of images are illustrated. Each pair comprising an image of the part of the field captured using a camera (302-a, 304-a, 306-a, 308-a) and a corresponding processed image with one or more parts of the field having the coefficients of traversal greater than the defined threshold highlighted (302-b, 304-b, 306-b. 308-b). Consider the pair 302-a and 302-b, the image 302-a comprises a part of the field having a tree and a part of the field around the tree that is flat. Base of a trunk of a tree is seen in the image 302-a. As seen in image 302-b, the part of the field where the base of the trunk of the tree is seen is dark and the part of the field that is flat around the tree is highlighted in white. Similarly in image 304-a, a block of wood is seen in a part of the field and remaining part of the field is flat. As seen in 304-b, the part having the block of wood is dark and the remaining part of the field that is flat is highlighted in white. Similarly, the pairs (306-a and 306-b, 308a and 308-b) the traversable part of the field is highlighted in white whereas the non-traversable part is highlighted in black.

Referring to FIG. 4, an example (400) of an identified traversable route (406) from a current location (402) of an FR to a target location (404) is shown. It may be noted that the target location (404) may be an intermediate target location for an image leading to a target location, in a field, received from a user.

Referring now to FIG. 5, an example (500) of a current location (502), a sequence of checkpoints (504-a, 504-b . . . 504-f), and a target location (506) received by the system is illustrated. The FR (not shown in figure) may be configured to start from the current location and reach the target location. The FR may be configured to pass through all the checkpoints before reaching the target location.

Referring now to FIG. 6, an example (600) of a direction (602) determined by the system from current location (502) to checkpoint 1 (504-a) in the example illustrated in FIG. 5 is shown. The direction (602) is towards the checkpoint 1 from the current location of the FR. The FR may be configured to initiate its journey towards the checkpoint 1 from the current location in the direction (602). The direction of the FR may be determined at each checkpoint towards a next checkpoint.

Referring now to FIG. 7, an example (700) of an image obtained by the system and a set of trajectories (704-a, 704-b, 704-c) sampled by the system from the current location (702) to the checkpoint 1 (708) for the image are shown. The image comprises a plurality of parts of the field (706-a, 706-b, 706-c). The set of trajectories pass through one or more parts of the plurality of parts of the field.

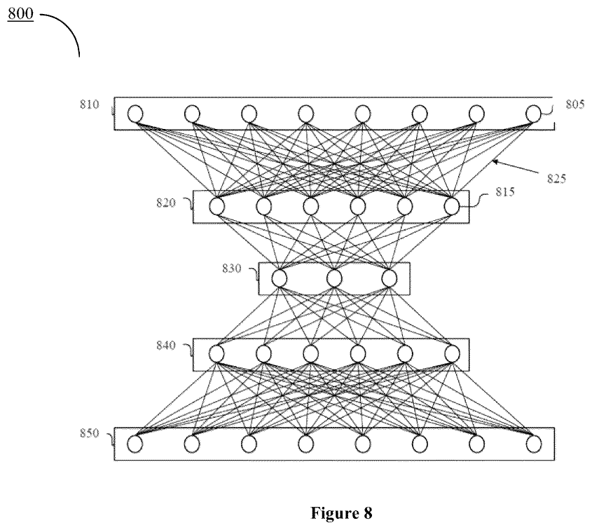

Referring now to FIG. 8 that illustrates an example artificial neural network (“ANN”) 800 of the deep learning algorithms. In an exemplary embodiment, an ANN may refer to a computational model comprising one or more nodes. Example ANN (800) may comprise an input layer (810), hidden layers (820, 830, 860,) and an output layer (850). Each layer of the ANN (800) may comprise one or more nodes, such as a node (805) or a node (815). In particular embodiments, each node of an ANN may be connected to another node of the ANN. As an example, and not by way of limitation, each node of the input layer (810) may be connected to one of more nodes of the hidden layer (820). In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 8 depicts a particular ANN with a particular number of layers, a particular number of nodes, and particular connections between nodes, this disclosure contemplates any suitable ANN with any suitable number of layers, any suitable number of nodes, and any suitable connections between nodes. As an example, and not by way of limitation, although FIG. 8 depicts a connection between each node of the input layer (810) and each node of the hidden layer (820), one or more nodes of the input layer (810) may not be connected to one or more nodes of the hidden layer (820).

In particular embodiments, an ANN may be a feedforward ANN (e.g., an ANN with no cycles or loops where communication between nodes flows in one direction beginning with the input layer and proceeding to successive layers). As an example, and not by way of limitation, the input to each node of the hidden layer 820 may comprise the output of one or more nodes of the input layer 810. As another example and not by way of limitation, the input to each node of the output layer 850 may comprise the output of one or more nodes of the hidden layer 860. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example, and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example, and not by way of limitation, an activation function may be an identity function, a binary step function, a logistic function, or any other suitable function.

In particular embodiments, the input of an activation function corresponding to a node may be weighted. Each node may generate output using a corresponding activation function based on weighted inputs. In particular embodiments, each connection between nodes may be associated with a weight. As an example, and not by way of limitation, a connection (825) between the node (805) and the node (815) may have a weighting coefficient of 0.4, which may indicate that 0.4 multiplied by the output of the node (805) is used as an input to the node (815). In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, the ANN may be trained using training data. As an example, and not by way of limitation, training data may comprise inputs to the ANN 800 and an expected output. As another example and not by way of limitation, training data may comprise vectors each representing a training object and an expected label for each training object. In particular embodiments, training the ANN may comprise modifying the weights associated with the connections between nodes of the ANN by optimizing an objective function. As an example, and not by way of limitation, a training method may be used (e.g., the conjugate gradient method, the gradient descent method, the stochastic gradient descent) to backpropagate the sum-of-squares error measured as a distance between each vector representing a training object (e.g., using a cost function that minimizes the sum-of-squares error). In particular embodiments, the ANN may be trained using a dropout technique. As an example, and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training the ANN in a particular manner, this disclosure contemplates training the ANN in any suitable manner.

Exemplary embodiments discussed above may provide certain advantages. Though not required to practice aspects of the disclosure, these advantages may include those provided by the following features.

Some embodiments of the system and the method may help in error free autonomous navigation of a field robot in an orchard.

Some embodiments of the system and the method helps the FR to automatically navigate in an agricultural field without any human intervention.

Some embodiments of the system and the method may prevent damage to the FR.

Some embodiments may detect repeated images to save processing time and memory.

Some embodiments of the system and the method enables continuous training and learning of the machine learning algorithms over a period of time to improve the efficiency of the autonomous navigation of the field robot.

Some embodiments of the system and the method may help in reducing human participation in autonomous navigation of the FR.

Although implementations for methods and system for autonomous navigation of a field robot have been described in language specific to structural features and/or methods, it is to be understood that the appended claims are not necessarily limited to the specific features or methods described. Rather, the specific features and methods are disclosed as examples of implementations for autonomous navigation of a field robot.

1. A method for autonomous navigation of a field robot (FR), the method comprising:
receiving, by a processor, a current location of the FR, a target location, and a sequence of checkpoints within a field, wherein a checkpoint from the sequence of checkpoints indicates an intermediate location between the current location and the target location on the field, wherein the sequence of checkpoints indicate field locations to be worked on by the FR by performing one or more agricultural tasks, and wherein the FR sequentially covers each checkpoint before reaching the target location;
determining, by the processor, a direction of navigation for the FR based on the current location, the target location, and the sequence of checkpoints;
obtaining, by the processor, a set of images of a plurality of parts of the field in real-time from one or more cameras installed on the FR during navigation of the FR in the determined direction;
determining, by the processor, coefficients of traversal of the plurality of parts of the field in each image of the set of images using an obstacle detection model and a Kinodynamic Motion Planning Model (KMPM), wherein the coefficients of traversal are determined based on a predicted future motility of the FR predicted using the KMPM and one or more obstacles detected in each image of the set of image, and wherein the obstacle detection model is trained based on a data set comprising a set of images with labeled obstacles; and
identifying, by the processor, a traversable route for the FR based on the coefficients of traversal of the plurality of parts, the target location, and the sequence of checkpoints using a route identification model.

2. The method of claim 1, wherein the current location is received from at least one of: a Global Positioning System (GPS) and a Global Navigation Satellite System (GNSS).

3. (canceled)

4. The method of claim 1, wherein the current location of the FR continuously changes as the FR moves, and wherein the set of images are continuously obtained using the one or more cameras.

5. The method of claim 1, further comprises tracking the current location of the FR to check when the FR passes through each checkpoint.

6. The method of claim 1, wherein the coefficients of traversal are further determined by:
identifying, by the processor, types of terrain of the plurality of parts of the field in the set of images using a terrain identification model; and
determining, by the processor, the coefficients of traversal based on the types of terrain identified.

7. The method of claim 1, wherein the coefficient of traversal of a part of the field is a value between 1 and 0, and wherein the coefficient of traversal is 1 when the part of the field is most traversable and 0 when the part of the field is least traversable.

8. The method of claim 1, further comprises highlighting one or more parts from the plurality of parts of the field having a coefficient of traversal greater than a defined threshold.

9. The method of claim 1, wherein the set of images comprises RGB (Red, Green, Blue) images and depth images of the plurality of parts of the field.

10. The method of claim 1, wherein the future motility is predicted based on direction, angular velocity, acceleration, yaw, pitch, roll angles, traction, and velocity of the FR.

11. The method of claim 1, wherein identifying the traversable route further comprises:
sampling a set of trajectories for the FR for each image based on the target location and the sequence of checkpoints;
computing an average coefficient of traversal for each trajectory based on the coefficients of traversal of the one or more parts of the plurality of parts of the field in the trajectory, wherein each trajectory passes through the one or more parts of the plurality of parts of the field; and
automatically selecting a trajectory with the highest average coefficient of traversal.

12. The method of claim 1, wherein the KMPM is trained using at least one of supervised learning, transfer learning, and recursive learning.

13. The method of claim 1, further comprises updating the coefficient of traversal of the plurality of parts of the field by:
receiving inertial information of the FR from inertial sensors installed on the FR;
determining a current motility of the FR in the part from the plurality of parts of the field based on the inertial information using the KMPM, wherein the inertial information comprises at least a current velocity, a current angular velocity, a current direction, and a current acceleration of the FR;
comparing the current motility with the predicted future motility of the FR for the part from the plurality of parts of the field; and
updating the coefficient of traversal of the part from the plurality of parts of the field based on the current motility when the current motility of the FR does not match the predicted motility of the FR for the part from the plurality of parts of the field.

14-16. (canceled)

17. A system for autonomous navigation of a field robot (FR), the system comprising:
a memory; and
a processor coupled to the memory, wherein the processor is configured to execute program instructions stored in the memory for:
receiving a current location of the FR, a target location, and a sequence of checkpoints within a field, wherein a checkpoint from the sequence of checkpoints indicates an intermediate location between the current location and the target location on the field, wherein the sequence of checkpoints indicate field locations to be worked on by the FR by performing one or more agricultural tasks, and wherein the FR sequentially covers each checkpoint before reaching the target location;
determining a direction of navigation for the FR based on the current location, the target location, and the sequence of checkpoints;
obtaining a set of images of a plurality of parts of the field in real-time from one or more cameras installed on the FR during navigation of the FR in the determined direction;
determining coefficients of traversal of the plurality of parts of the field in each image of the set of images using and a Kinodynamic Motion Planning Model (KMPM), wherein the coefficients of traversal are determined based on a predicted future motility of the FR predicted using the KMPM and one or more obstacles detected in each image of the set of image, and wherein the obstacle detection model is trained based on a data set comprising a set of images with labeled obstacles; and
identifying a traversable route for the FR based on the coefficients of traversal of the plurality of parts, the target location, and the sequence of checkpoints using a route identification model.

18-20. (canceled)

21. The method of claim 1, wherein the future motility includes an ability of the FR to traverse through a part of the field.
